(19) United States
(12) Patent Application Publication
(10) Pub. No.: US 2024/0112121 A1
(43) Pub. Date: Apr. 4, 2024

(54) COMPETITIONS WITH RESTAURANT TASK PERFORMANCE INDICATOR FEEDBACK

(71) Applicant: TipHaus, Inc., Port Orchard, WA (US)

(72) Inventors: Macgregor GAINOR, Bellingham, WA (US); Taylor BIRKELAND, Seattle, WA (US); Leif MAGNUSON, Seattle, WA (US)

(21) Appl. No.: 17/959,977

(22) Filed: Oct. 4, 2022

(51) Int. Cl. G06Q 10/06; G06Q 50/12

(52) U.S. Cl. CPC G06Q 10/06393; G06Q 10/06398; G06Q 50/12

(57) ABSTRACT

This disclosure describes disclosure describes systems and methods for competitions with restaurant task performance indicator feedback. Competitions for restaurant workers may include attempting to achieve a mark towards a goal that can be defined by restaurant owners or operators for a variety of purposes. Competition awards may be given to the restaurant workers to obtain the goal such as promoting a particular product or improving services offered by the restaurant owners or operators.

### BACKGROUND

For certain service-based businesses, it is customary for customers to give a gratuity, or tip, to one or more employees who perform a service. Although a business customer may primarily interact with a subset of employees of the service-based business, such as a server and a host of a restaurant, many other employees may have contributed or assisted in varying degrees in supporting the service provided to the customer. In a restaurant, for example, a host may initially entertain and seat the customer to a table, a kisser may set and clear the table, a food runner may deliver food to the table, a bartender may prepare and/or serve alcoholic beverages, a valet driver may bring customer's car to a main entrance, and other employees may similarly provide specific services for the benefit of the customer during their dining experience.

At an end of a customer transaction, such as when the customer pays for the service, the customer may have the opportunity to give a gratuity directly to the server or add the gratuity to an amount paid for the meal, for example. In some scenarios, the gratuity encourages the employees to enhance their customer service skills to gain more customers and thus, a greater number of tips. In other scenarios, a focus on gratuities can be out of alignment with other business goals. Accordingly, different performance indicators may be desirable.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a diagram of an example computing environment, in accordance with at least one embodiment.

FIG. 2 is a diagram of an example computing environment including a competition engine, in accordance with at least one embodiment.

FIG. 3 is a diagram of an example data structure that can be used by the competition engine to identify parameters of task competitions in the subscriber establishment, in accordance with at least one embodiment.

FIG. 4 is an example subscriber user interface that shows accessing of a competition configurator for manual configuration of various fields and conditions that may effect changes in input data and scoring metrics for the task competitions, in accordance with at least one embodiment.

FIG. 5 is an example user device interface that shows accessing a competition monitor to view the task competitions and corresponding updated scores and ranking of a task competition participant in the task competitions, in accordance with at least one embodiment.

FIG. 6 is an example of apportionment of regular gratuities, in accordance with at least one embodiment.

FIG. 7 is a flow diagram of an example procedure, in accordance with at least one embodiment.

FIG. 8 is a flow diagram of another example procedure, in accordance with at least one embodiment.

### DETAILED DESCRIPTION

This disclosure describes systems and methods for competitions with restaurant task performance indicator feedback. Competitions for restaurant workers may include attempting to achieve a mark towards a goal that can be defined by restaurant owners or operators for a variety of purposes. Competition awards may motivate the restaurant workers and can be targeted to a variety of restaurant owner or operator goals such as average or highest revenue per customer or per table, average or highest tip per table or per customer, average or lowest table occupancy time, number of targeted menu items or drinks, and repeat customer statistics. In one embodiment, restaurant owners may use a graphical user interface to define the competitions from templates or task components. A competition engine may use the competition definitions to process competition-relevant events (or input data) generated by restaurant workers and maintain corresponding restaurant worker competition scores. Notifications, including real-time updates, may be sent to participating restaurant workers regarding their competition status and/or progress of each competition in which they are participating, and these notifications may serve as the restaurant task performance indicator feedback. When a competition is finished in accordance with the competition definition, the competition awards, including monetary awards, may be distributed to competition participants who qualify in accordance with the competition definition.

Worker gratuities may be derived directly from customers (regular gratuity) or sponsored by the restaurant owner and/or a distributor of a product or service to be promoted (sponsored gratuity). Distribution of the regular gratuity may be based upon employees' preconfigured percentage sharing, where the employees' percentages can be associated with their assigned or actual working hours; participation over a particular service or order; length of overlapping shifts between employees; employees' positions/levels; and other preconfigured conditions that relate to an apportioning of the regular gratuities pooled within a gratuity distribution period. The distribution (or sharing) of the sponsored gratuity may be based upon winning competition awards in a task competition such as, but not limited to, competing on amount of revenue per customer, tip per customer, number of customers served, a number of repeat customers served, earliest arrival at the job site, and the like, within the gratuity distribution period. In one instance, the competition award can be a form of gratuity such as the sponsored gratuity. Alternatively, or in addition, the competition award may be classified as a type of income that is different from the gratuity as another type of income. For example, as a condition of a worker's employment, the competition award may be treated as a Miscellaneous Income and declared via a Form 1099 for tax purposes while the gratuities are added in the worker's regular wages. In this example, the competition award is not a form of gratuity or even a sponsored gratuity and thus treated as an independent type of income of the worker. For illustration purposes in the discussion below, the competition award may be a form of “sponsored gratuity” and interchangeably referred to as sponsored gratuity, which is distinct from the regular gratuity.

In one embodiment, the distribution of the regular gratuity may be independently calculated from the competition award although events during the apportionment of the regular gratuity can also be used to trigger distribution of the competition award. In this embodiment, the competition award may be treated as a form of sponsored gratuity in a case where the worker's condition of employment treats the competition award as another form of gratuity type of income rather than a separate type of income in the preceding example.

The gratuity distribution period may include a distribution frequency of the gratuities to employees, which frequency can be hourly, daily, weekly, end of working shift, end of the month, or some other periodic pattern. The gratuity distribution period can also be set according to an aperiodic factor such as, without limitation, when it is based on the time of sale where the gratuity distribution period can be defined by a start/opening of an order or transaction (such as a bartender entering a liquor tab number for a customer or a host registering a particular dining table for the customer) to closing or entry of the time-of-sale (input data entries at, e.g., a register) for the rendered service or completed order; the time a delivery person leaves with an order until the order is delivered; the time a task competition participant wins a restaurant task competition or some other aperiodic pattern. The gratuity distribution period may be different from an employee's pay period or payment of wage, which can cover multiple gratuity distribution periods.

As described herein, gratuities may include the sponsored gratuities that can be derived from a subscriber establishment itself or from a sponsor of the product or services to be rendered by the subscriber establishment. For example, the sponsored gratuities may include the task competition awards or prizes given by the subscriber establishment or a distributor of the products that are sold in the subscriber establishment. Gratuities may also include regular gratuities that can be pooled from the customers of the subscriber establishment. For example, the regular gratuities may include diner tips, gifts, presents, donations, or handouts from the customer. These gratuities can be distributed to the employees in addition to any corresponding base wages.

In one embodiment, a user such as a store manager may preconfigure the percentage sharing of a particular employee over the pooled regular gratuity based upon the employee's time of work, participation over the rendered service or completed order, position or change in position during the rendering of the service or order, user profile, and/or other criteria or parameters that can distinguish the percentage sharing of the particular employee from that of another employee. The store manager may also preconfigure parameters of the restaurant task competition including an identification of the task competition, input data, and scoring schemes to receive or win the task competition. In such embodiments, the distribution of the pooled regular gratuity may use a separate algorithm from the distribution of the competition award. In some embodiments, an integrated algorithm may be utilized to distribute the regular gratuity and the competition award (or sponsored gratuity).

The gratuities including the competition award (or algorithm output data in some examples) may then be forwarded to one or more entities such as a bank or other financial institution, tax agency, bankruptcy court, collecting agency, credit card companies, etc. that can further utilize and process the output data for other purposes such as, without limitation, direct payment by bank of employee's wages, tax agency updating employee's income tax returns, bankruptcy court garnishing or levying the employee's gratuity shares/income, and the like. This technique of automating the distribution of the gratuities including the competition awards over the gratuity distribution period may improve business accounting efficiency and can further increase cohesion among employees on account of visibility into the sharing to assure that gratuities and competition awards are shared fairly and/or according to a known policy. Further, task competitions may further engage the employees to improve their customer service skills and motivate them to promote the subscriber products or services.

The implementation and operations described above are ascribed to the use of the server; however, alternative implementations may execute certain operations in conjunction with or wholly within a different element or component of the system(s). Further, the techniques described herein may be implemented in a number of contexts, and several example implementations and contexts are provided with reference to the following figures. In addition, the term “techniques,” as used herein, may refer to system(s), method(s), computer-readable instruction(s), module(s)m algorithms, hardware logic, and/or operation(s) as permitted by the context described above and throughout the document.

### Example Network Server Environment

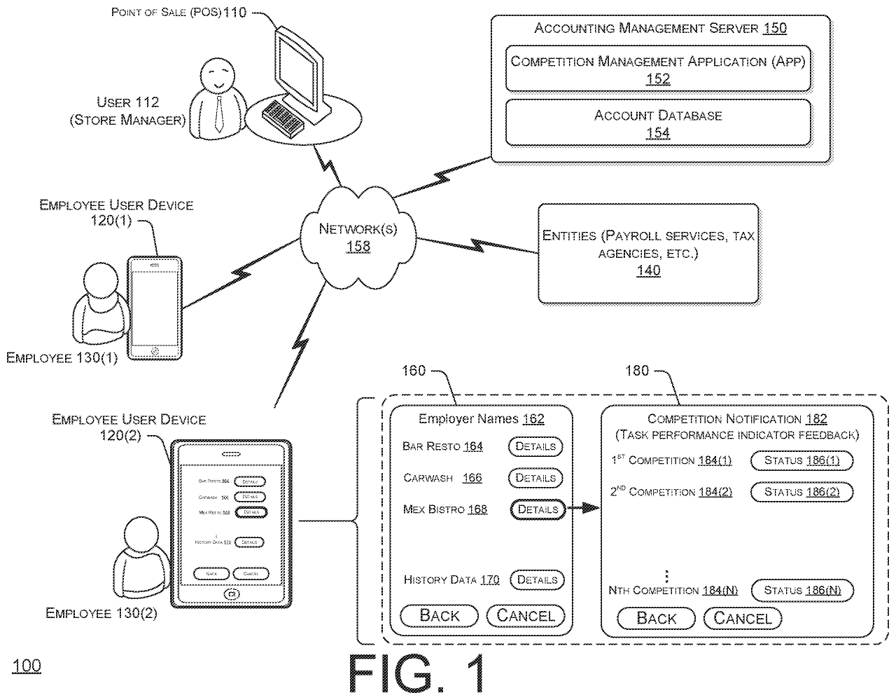

FIG. 1 illustrates a schematic view of a network server environment 100 that facilitates an automated distribution of gratuities and competition awards among employees of subscriber-establishments (or subscribers) such as restaurants, carwash services, online or offline delivery providers, golf caddy operators, disc jockey services, babysitter services, or similar employers or establishments that can provide sharing of pooled gratuities among their employees or workers. In one embodiment, a network server, which can represent a subscription service provider, may receive input data from a subscriber, process the input data, generate output data that can indicate how gratuities including the competition awards are to be distributed, and transmit the output data back to the subscriber and/or other entities. The network server may also store, integrate, and/or reconcile output data that can include apportioned gratuities and competition awards of employees who may be working for different subscribers. This technique of automating the distribution and/or reconciliation of the gratuities and the competition awards may improve efficiency in business accounting practices on the part of the subscribers and further implement fair sharing among the subscribers' employees, contractors, sub-contractors, and the like.

In one example, the competitions rewards may include prizes from reaching a particular goal of a defined task competition. The defined task competition may include an identification of the task competition, conditions for qualification, scoring schemes, and a goal to be achieved. The task competition for the restaurant business may include competing for a number of customers served, total amount of a particular liquor sold, number of repeat customers served during a time period or shift, and/or competing for a preconfigured target that can engage or increase participation of the employees. The competition rewards may be funded by the subscriber, an outside entity or a different subscriber, or a distributor that owns the products or services to be rendered through the subscriber. In one embodiment, an activity or event during distribution of regular gratuities may trigger the calculation of the competition rewards to update task competition ranking and/or competition status of each participant. The competition status, for example, may include participant ranking, updated score, goal to be achieved, and the like. The events and activities during the distribution of the (regular) gratuities is described in a commonly assigned U.S. patent application Ser. No. 17/723,108, entitled “Automated Distribution of Gratuities,” the subject matter of which is incorporated herein by reference.

As shown, the network environment 100 may include a point-of-sale device (POS) 110 of a particular subscriber (e.g., an operator of one or more restaurants), a user 112 such as a store manager, user devices 120(1), 120(2) that are associated with employees 130(1), 130(2), respectively, one or more entities 140, a network server such as an accounting management server 150, and one or more networks 158. The accounting management server 150 may further include a competition management app 152 and an account database 154. In some embodiments, the network environment 100 may be or include a cellular network.

Referencing the user device 120(2), and at a first instant 160, the employee 130(2) may view on the user device's user interface one or more of employee's employer names 162 such as a bar restaurant 164, carwash 166, and Mex bistro 168. A button link to history data 170 may also be shown at the first instant 160. At a second instant 180, and upon clicking/opening further details of the Mex bistro 168 by clicking the adjacent “Details” button, the employee 130(2) can also view a competition notification 182, which can include, for example, task competitions 184(1)-184(N) and corresponding status 186(1)-186(N). The task competitions 184(1)-184(N) may include corresponding goals to be achieved to win the competition awards. The status 186(1)-186(N) may indicate employees ranking towards the goal to be achieved, stage of the competition such as halfway or near the end of the goal, amount of award, earned competition awards by the employee from previous competition, scoring schemes for the competition, algorithm used, and the like.

The account database 154 may store the information of the subscribers, preconfigured competitions, or templates of competitions of the corresponding subscribers, details and parameters of the task competitions, algorithms used for calculating the competition awards, and the like. As shown, the number of blocks, information, employees, and associated user devices are for illustration purposes only, and additional POSs, employees, and user devices can be included within the scope of the embodiments described herein.

The user 112 and employees 130(1), 130(2) may include individuals who are working in a restaurant for illustration purposes. In one embodiment, the user 112 may be a store manager who can configure, via the POS 110 and/or by accessing the accounting management server 150, the apportioning of the regular gratuities among the employees over a gratuity distribution period, which can include a periodic cycle, aperiodic distribution frequency of the gratuities, or a combination thereof. For example, the periodic cycle may be every hour, end of day, end of week, or some other fixed time period. The aperiodic cycle can be after winning a task competition, rendering of a particular service or completion of a customer order at the time-of-sale, random clocking in and out by an employee based upon a need of the subscriber, happening of an event during an employee's shift, winning of the task competition, or other aperiodic arbitrary condition that can be associated with the calculation of the pooled regular gratuity or rewarding of the sponsored gratuity.

In some embodiments, the configuring by the user 112 (store manager) may include entering the employee's personal information, assigned job code, job position, percentage sharing (over regular gratuity) for the job position or type of service, and adjustment in the percentage sharing (over the regular gratuity) at a certain day of the week or upon the occurrence of a condition. Further, the configuring by the store manager may include defining and/or setting parameters for the different task competitions 184(1)-184(N). The parameters may include identifications of the task competitions, qualifications to join each of the task competitions, input data that are representative of components of the task competitions, and scoring metrics. The qualification, for example, may include being a full-time employee, night-shift employee, assigned to a particular position, and the like. The input data or the components of the task competition may include, for example, the number of products or targeted menu sold, the number of customers serviced, the number of tips over a particular period, and the like.

In one example, the scoring metrics may include scoring rules to rank or facilitate identification of the winners of the task competition 184(1)-184(N). The scoring metrics may use set values, threshold values, preconfigured weights for different components of the task competition, or a combination thereof. The set values or threshold values may include a preconfigured number or amount that can be used as a reference to determine the winner of the task competition. For example, the set value may include “5 items” as a target for menus sold in a particular shift. In another example, the threshold value may include a minimum amount of “$100” customer tip to win the task competition. The preconfigured weights may include coefficients or assigned values to calculate an average value. For example, equal preconfigured weights are given to the number of products sold and the total number of customers served for the particular shift. In this example, the preconfigured weights of these components may be used in calculating the average value or updated score of the task competition participant.

The POS 110 and/or the user devices 120(1), 120(2) may include an electronic communication device, including but not limited to, a smartphone, a session initiation protocol (SIP) phone, a laptop, a personal digital assistant (PDA), a satellite radio, a global positioning system (GPS), a multimedia device, a video device, a camera, a game console, a tablet, a smart device, a wearable device, or any other similar functioning device. In one embodiment, the POS 110, and/or the user devices 120(1), 120(2) may communicate with the accounting management server 150 to avail of automated distribution and/or reconciliation of gratuities and the competition awards. Further, the POS 110, and/or the user devices 120(1), 120(2) may be used to enter input data or input variables for the scoring metrics as described herein.

A network server such as the accounting management server 150 may utilize distributed computing resources (e.g., one or more computing devices) that can operate in a cluster or other configuration to share resources, balance load, increase performance, provide fail-over support or redundancy, or for other purposes. The accounting management server 150 may include one or more interfaces to enable communications with the POS 110, user devices 120, and other networked devices via the one or more network(s) 158. The one or more network(s) 158 may include public networks such as the Internet, private networks such as an institutional and/or personal intranet, or some combination of private and public networks. The one or more network(s) 158 can also include any type of wired and/or wireless network, including but not limited to local area network (LANs), wide area networks (WANs), satellite networks, cable networks, Wi-Fi networks, Wi-Max networks, mobile communications networks (e.g., 3G, 4G, and so forth), or any combination thereof.

The one or more entities 140 may include another server or servers that can be operated by financial institutions, payroll agencies, tax agencies, bankruptcy court, credit card companies, collection agencies, payday loan lenders, creditors, or other institution that can process output data from the accounting management server 150. In one embodiment, the one or more entities 140 may implement access policies to control access by the subscribers to their corresponding output data or other subscriber information/data for further processing. The subscriber information/data may include the name of the subscriber, its (or its user) status and limit of authorization, etc.

In an example operation, the user 112 (store manager) may preconfigure the parameters of each of the restaurant task competitions 184(1)-184(N) including an identification of the task competition, input data or components for each task competition, identification of authorized devices that can supply the input data, and scoring metrics that can be used to determine the ranking or the winning participant. In this example operation, the determining of the winning participant may be executed continuously, periodically, or upon a detection of a triggering event such as a closing of a transaction at the time-of-sale.

In one embodiment, the competition management app 152 may continuously generate output data to update the task competition participants on their respective scores and ranking in the task competitions. Each of the status 186(1)-186(N) may indicate the status and/or competition updates over corresponding task competitions 184(1)-184(N). Similarly, the competition management app 152 may allow the user 112 to enter new task competitions, components of the task competitions, adjustments in the scoring metrics, and the like, via the POS 110 or other user devices that are authorized to access the competition management app 152.

With the calculated gratuity earnings and competition awards at the end of the gratuity distribution period, the gratuity earnings and the competition awards may be stored in the account database 154 where the stored data can be accessed by the user devices 120, the subscriber POS 110, one or more entities 140, and/or other network devices. In some cases, authorization from the user 112 or subscriber may be needed for the other network devices to access the subscriber's or employee's data.

For example, the user device 120(2) that is associated with the employee 130(2) may be authorized to access the stored data to check the competition notification 182 that includes the task competitions 184(1)-184(N) and corresponding status 186(1)-186(N). As shown at the first instant 160, the employee 130(2) can view at a user interface a different employer, if the employee holds more than one job whose employer also subscribes to the service that provides the automated distribution of gratuities. The employee 130(2) may then view additional details of the task competitions participated in by the employee as shown at the second instant 180. Here, the employee can view the updated competition notification for the Mexican bistro where the competition notification may serve as the task performance indicator feedback in the illustrated example. In one embodiment, and every pay period, a particular entity such as an employee's bank may process the data from the accounting management server 150 to facilitate the direct deposit of the employee's earned earnings to the employee's bank account. In another embodiment, another entity such as a collecting agency may process the data from the accounting management server 150 to garnish the employee's earned earnings for child support, and so on.

The history data 170 may store competitions participated in by the employee, identification of task competition won or lost, previous competition notifications, and data associated with the participation of the employee on the task competitions. In one embodiment, the data may be used in a statistical algorithm to calculate chances of the associated employee to win the task competition. For example, the employee 130(2) won the last 1^{st} competition 184(1), which is based on the number of customers served. In this example, the corresponding status 186(1) for this task competition may indicate statistical chances of the employee 130(2) to win the 1^{st} competition 184(1). Here, the employee 130(2) may focus on the 1^{st} competition 184(1) versus the other task competitions 184(2)-184(N) in order to get the associated competition award.

### Example Network Server Implementation in a Network Server Environment

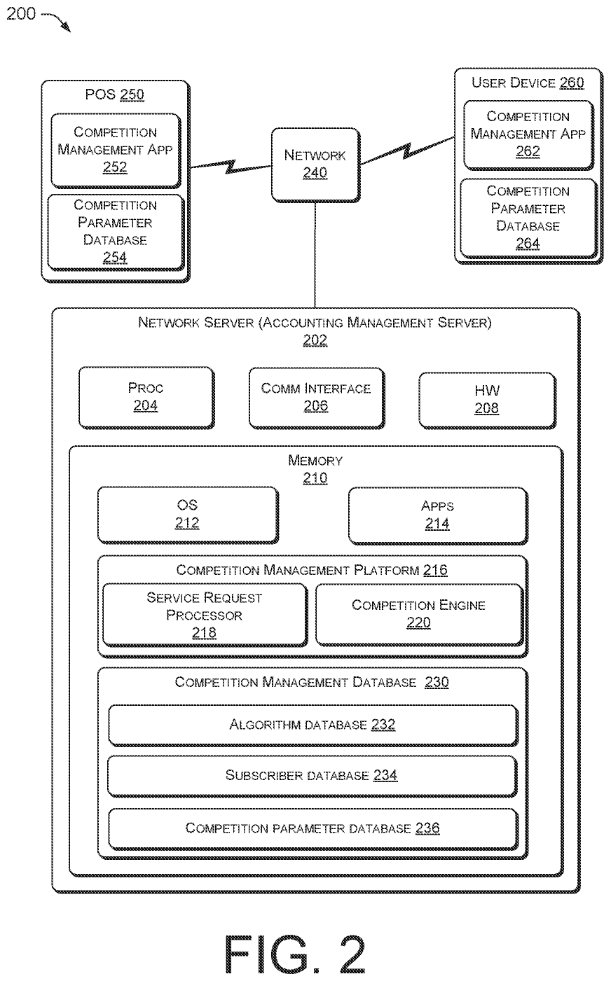

FIG. 2 is a diagram of an example network server environment 200 in which an accounting management server may be implemented, in accordance with at least one embodiment. For example, the network server environment 200 may include a network server 202 that corresponds to the accounting management server 150 of FIG. 1. The network server 202 may be communicatively connected, via a network 240, to a POS 250 and a user device 260. The POS 250 and the user device 260 may correspond to the POS 110 and the user device 120, respectively, of FIG. 1.

The network server 202 may include one or more processors 204 having electronic circuitry that executes instruction code segments by performing basic arithmetic, logical, control, memory, and input/output (I/O) operations specified by the instruction code. The processors 204 can be a product that is commercially available through companies such as Intel® or AMD®, or customized to work with and control a particular system.

The network server 202 also includes a communications interface 206 and miscellaneous hardware 208. The communication interface 206 may communicate with components located outside the network server 202 and provide networking capabilities for the network server 202. For example, the network server 202, by way of the communications interface 206, may communicate with subscribers and one or more entities that can be authorized by the subscribers to use the subscriber data. The subscriber data may include regular gratuities and/or task competition rewards that can be distributed at each gratuity distribution period, pay period, or preconfigured period for the distribution of the task competition rewards. The subscriber data may also include associated subscriber information such as, without limitation, employee job codes, positions, hours of work, etc. Further, the subscriber data may include parameters of the task competitions, task notification that may be representative of the task performance indicator feedback, and other information associated with the goals of each task competition. Communications between the network server 202 and the user devices or requestor devices may utilize any sort of communication protocol known in the art for sending and receiving data and/or voice communications.

The miscellaneous hardware 208 may include hardware components and associated software and/or firmware used to carry out device operations. Included in the miscellaneous hardware 208 may be one or more user interface hardware components not shown individually—such as a keyboard, a mouse, a display, a microphone, a camera, and/or the like—that support user interaction with the network server 202.

The network server 202 also includes memory 210 that stores data, executable instructions, modules, components, data structures, etc. The memory 210 may be implemented using computer-readable media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc-Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media may embody computer-readable instructions, data structures, program modules, or other data in a modulated data signal, such as a carrier wave, or other transmission mechanisms.

An operating system 212 may be stored in the memory 210 of the network server 202. The operating system 212 can control a functionality of the processor(s) 204, the communications interface 206, the miscellaneous hardware 208, and couples the processor(s) 204 with the memory 210. Furthermore, the operating system 212 may include components that enable the network server 202 to receive and/or transmit data via various inputs (e.g., user controls, network interfaces, and/or memory devices), as well as process data using the processor(s) 204 to generate output. The operating system 212 can include a presentation component that controls presentation of output (e.g., display the data on an electronic display, store the data in memory, transmit the data to another electronic device, etc.). Additionally, the operating system 212 can include other components that perform various additional functions generally associated with a typical operating system. The memory 210 that is in communication with the processor(s) 204 also stores various software applications 214, or programs, that provide or support functionality for the network server 202, or provide a general or specialized device user function that may or may not be related to the example computing device per se.

The one or more processors 204 and the memory 210 may implement a competition management platform 216 that may correspond at least in part to the competition management app 152 of FIG. 1, including such software as routines, program instructions, objects, and/or data structures that are executed by the processors 204 to perform particular tasks or implement particular abstract data types. The one or more processors 204 in conjunction with the competition management platform 216 may further operate and utilize a service request processor 218, a competition engine 220, and a competition management database 230 including an algorithm database 232, a subscriber database 234, and a competition parameter database 236. The subscriber database 234 may correspond at least in part to the account database 154 of FIG. 1.

The competition management platform 216, when executed, may manage the automated distribution and/or reconciliation of the gratuities including the awarding of task competition prizes among subscriber employees over one or more gratuity distribution periods. The competition management platform 216 may run, for example, one or more algorithms and/or sub-algorithms to generate output data that may include gratuity earnings and competition awards for each of the employees over the one or more gratuity distribution periods. The gratuity earning may include the regular gratuities. In some embodiments, the competition awards may be a form of sponsored gratuities when treated to be the same type of income as that of the gratuity income. For example, the competition awards and the regular gratuities are combined directly with the base wage of the employee. The competition management platform 216 may be a single block of executable instructions or it may be made up of several components. The components included in at least one implementation are described elsewhere herein. However, it is noted that in some implementations, more or fewer components may be configured and that one or more operations attributed to a particular component in the following description may be implemented in one or more other components.

The service request processor 218 may process one or more service requests that can be received from the POS 250 or user devices that are associated with the subscriber's employees. One functionality of the service request processor 218 may be to verify the source of the service request. For example, the service request processor 218 may parse the parameters of the received service request and use the parsed parameters, such as an identification of the user device 260, to verify whether the device identification is associated with a particular subscription. In this example, the subscriber may authorize during an initial sign-up or during a period of subscription to the competition management platform 216 the user device or devices, POSs, and/or entities that can access subscriber data or employee data. Access to the subscriber data or employee data may be performed via the use of a username, email address, job code, and/or the like.

The competition engine 220 may be configured to run a first set of algorithms associated with defined task competitions to distribute the task competition rewards over one or more gratuity distribution periods for each of the subscriber establishments. In one embodiment, the competition engine 220 may also a second set of algorithms to calculate the gratuities to be apportioned for different time windows within a particular gratuity distribution period. In at least one embodiment, the first set or second set of algorithms may be executed continuously, periodically, or upon the detection of a triggering event. In this embodiment, the first set of algorithms may use different input data from that of the second set of algorithms. For example, the first set of algorithms may use parameters of the task competition while the second set of algorithms can utilize the preconfigured conditions for the distribution of the regular gratuity such as type of assignment, status of employment whether full-time or part-time employee, etc.

The algorithm database 232 may store preconfigured algorithms and/or sub-algorithms, associated input variables, and other information that can be used for distributing rewards over different competitions such as the task competitions 184(1)-184(N) of FIG. 1. In one embodiment, the subscriber may preconfigure the conditions that can trigger the running of the algorithms or sub-algorithms, input variables to be utilized based upon the parameters of the defined task competitions, and the storing of the output data in the subscriber database 234.

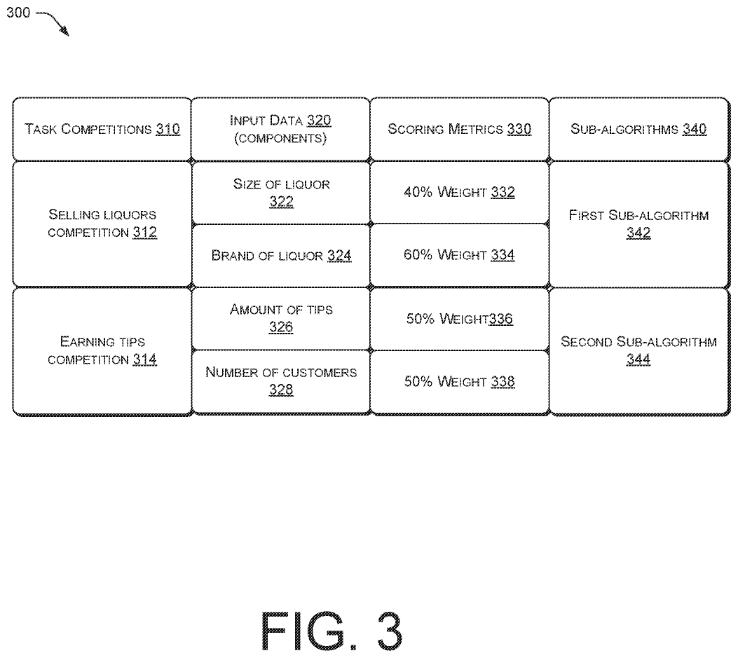

In one embodiment, the parameters of the task competition may include an identification of the task competitions and associated components of the identified task competition. For example, the components of the restaurant task competition may include competing for a number of customers served over a particular shift or hour, the total amount of a particular liquor sold, the number of repeat customers served, the number of target menus offered or sold, and the like. In this example, different scoring metrics may be preconfigured for each task competition and/or component of the task competition to determine the winner. The different scoring metrics may use a set value, threshold value, preconfigured weight of the components, or a combination thereof, as a reference to rank or classify the winning employee among the task competition participants. An example specification of the task competition is further described in detail in FIG. 3 below.

The subscriber database 234 may store the information associated with the subscriber establishments, such as the name of the establishment, nature of the establishment, employee information, gratuity distribution periods observed by the subscribers for their employees, competition rewards distribution periods, authorized subscriber personnel who can configure the specification of the task competition and/or percentage sharing of the employees, different sources of gratuities within the subscriber establishment, and the like. In one example, the employee information may include personal information, the device identification associated with the employee, employee position, and the like.

The competition parameter database 236 may store defined task competitions including preconfigured input variables or components, scoring metrics, parameters of the task competition, and associated algorithm(s) for calculating the scores of the task competition participants. In one embodiment, the competition management platform 216 may use the stored data in the competition parameter database 236 to generate the competition notification such as the competition notification 182 of FIG. 1. Here, the competition notification may include the task competition and corresponding competition updates that can be displayed in the POS 250 and/or the user device 260. In this embodiment, the algorithm(s) may be executed continuously, periodically, or upon the detection of the triggering event.

In one embodiment, the POS 250 may be associated with a particular subscriber establishment and includes components such as a competition management app 252 and a competition parameter database 254. In this embodiment, the POS 250 may be used to periodically or in real-time send events or activities to the network server 202 for further processing. The events may include, without limitation, sales entries, amounts of regular gratuities, a timestamp for payment of the regular gratuities, a timestamp for opening a transaction such as entering a tab number for a customer or designating a dining table for the customer, timestamp for ending of rendering service to customers or completing an order such as entering bill payment or closing of the tab number, clocking in and out by employees, changes in gratuity distribution period, assigned percentage sharing of the regular gratuity for a certain position, or adjustments in percentage sharing of the employee. The events may further include conditions and details for winning the task competitions and other data that relate to the distribution of the competition awards over one or more gratuity distribution periods.

The user device 260 may be the employee's electronic device that can be used to access the employee's earnings from one or more employers and/or view the task competition notification including the updated scores, ranking in the task competitions, amount left to reach the goal, parameters of the goal, amount of awards, and the like. In one example, the user device 260 may utilize the competition management app 262 to access the network server 202 and transmit events that can be used as triggering events. For example, a Wi-Fi connection between the user device 260 and the POS 250 may indicate clocking in by the employee upon the employee's physical arrival at the location of the subscriber establishment. The user device 260 may also include the competition parameter database 264 to store the defined task competitions and the associated parameters or specification of the defined task competitions.

### Example LUT for Distributing Sponsored Gratuities

FIG. 3 is a block diagram of an example data structure 300 that can be used by the competition management platform 216 to identify parameters of the defined task competitions and apportion the rewards from the task competition prizes. In one embodiment, the data structure 300 may be a look-up table (LUT) that can be preconfigured to determine the one or more winning employees in the one or more task competitions. In this embodiment, the LUT may be stored in the competition parameter database such as the competition parameter database 236 of FIG. 2.

As shown, the data structure 300 may include task competitions 310, input data 320, scoring metrics 330, and associated sub-algorithms 340. The task competitions 310 can be representative of an undertaking to achieve a defined goal that is to be performed by the one or more employees. For example, in a restaurant business, the task competitions 310 may include selling liquors competition 312 and earning tips competition 314. In this example, the selling liquors 312 may involve a competition or desired goal of disposing of liquors to customers while the earning tips competition 314 may include a competition or desired goal of gathering regular gratuities over a particular time period. For illustration purposes, only two task competitions 310 are shown and different other task competitions (e.g., car valeting, selling a number of targeted menus, etc.) can be included without affecting the embodiments herein. Further, only two components or input data for each task competition is shown and additional components may be preconfigured without affecting the embodiments herein.

The input data 320 (or input variables) may include preconfigured arbitrary components of the corresponding task (or task competition). For example, the input data 320 or components for the selling liquors competition 312 may include a size of liquor 322 and a brand of liquor 324. In this example, the restaurant may be promoting a particular size and brand of liquor and in this regard, the components for the task—selling liquors competition 312 may be based upon the sizes and brand of the liquors to be sold over a particular time period.

In another example, the input data 320 for the earning tips competition 314 may include amount of tips 326 and number of customers 328. In this example, the restaurant may be focusing on engaging the employees to improve their customer service skills and on this regard, the components of the earning tips competition 314 may be based on the amount of tips and number of customers served by the competing employee over a particular time period such as one hour, two hours, end of shift, and the like.

The scoring metrics 330 (or scoring rule) may include a preconfigured scoring rule that can be used to rank or measure the performance of the task competition participants on each of the task competitions 310. In one embodiment, the scoring metrics 330 may use a set value, threshold value, different preconfigured weight for each of the components (input data), or a combination thereof. For example, the scoring metrics 330 for the size of liquor 322 and brand of liquor 324 (i.e., components of the selling liquors competition 312) may include a preconfigured 40% weight 332 and 60% weight 334, respectively. In this example, a first sub-algorithm 342 may utilize these preconfigured weights to measure the corresponding scores of each of the task competition participants. The first sub-algorithm 342 may use the size of liquor 322 and the brand of liquor 324 as independent variables to rank or update the scores of the competing employees.

In another example, the scoring metrics 330 for the amount of tips 326 and number of customers 328 (i.e., components of the earning tips competition 314) may include a preconfigured 50% weight 336 and 50% weight 338, respectively. In this example, a second sub-algorithm 344 may utilize these preconfigured weights to measure the corresponding scores of the task competition participants. The second sub-algorithm 344 may use the amount of tips 326 and the number of customers 328 served as independent variables in ranking or updating the scores of the competing employees.

In some embodiments, one or more task competitions 310 may be combined to determine the winner for the task competition. Here, different scoring metrics 330 may be utilized to measure the performance of the competing employees. For example, the selling liquors competition 312 and the earning tips competition 314 may be combined as a single task competition. In this example, the components of these task competitions 310 may be combined and used in an algorithm to calculate the scores of the task competition participants. Here, the preconfigured weights for the size of liquor 322, a brand of liquor 324, amount of tips 326, and number of customers 328 total 100% weight.

### Example Subscriber User Interface

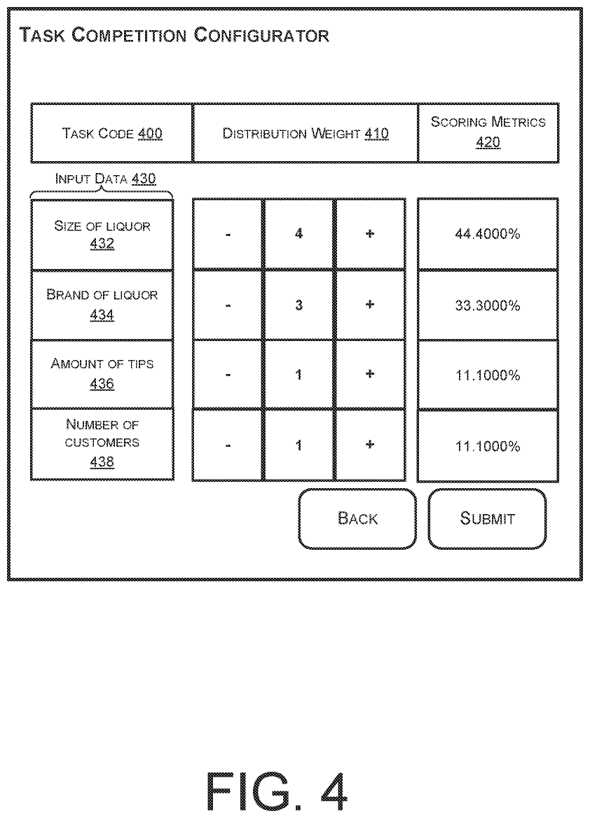

FIG. 4 is an example subscriber user interface that shows accessing the competition management app to manually configure various fields, parameters, and conditions that may effect changes in input data and scoring metrics for the task competitions, in accordance with at least one embodiment. As shown, the subscriber user interface may include fields for entry of parameters, e.g., by a subscriber/user, to enforce a task competition policy. In the illustrated example, those fields may include entries for a task code 400, a distribution weight 410, scoring metrics 420 for the task code 400, and input data 430. The task code 400 may be representative of the task competitions such as the task competitions 184(1)-184(N) of FIG. 1. Different task competitions may correspond to a different task code 400. The input data 430 may include the components of the task code 400 to be preconfigured or manually adjusted as shown.

In the example shown in FIG. 4, which is not limited to the fields or values shown, the task code 400 may represent a combined selling liquors and earning tips competitions such as the selling liquors competition 312 and earning tips competition 314 of FIG. 3. Here, the components (input data 430) of the task code 400 may include a size of liquor 432, brand of liquor 434, amount of tips 436, and number of customers 438, which correspond to the size of liquor 322, brand of liquor 324, amount of tips 326, and number of customers 328 of FIG. 3. In one embodiment, the input data 430 may be assigned with corresponding distribution weight 410 to generate the corresponding scoring metrics 420. In this embodiment, each of the input data 430 may be used as an input variable in an algorithm or sub-algorithm to rank or update the scores of the task competition participants.

As illustrated, the subscriber (e.g., manager, supervisor, data entry clerk, or the like) may select one or more input data 430 and enter values for the distribution weight 410 for each of the selected input data via the POS user interface to adjust on the fly the scoring metrics 420 associated with each input data. The task code 400, input data 430, and corresponding scoring metrics 420 may be preconfigured and stored in the competition parameter database such as the competition parameter database 236 of FIG. 2.

In one example, adjustments to the distribution weights and other parameters that are tied to distribution amounts may be forwarded to the network server, and the network server may adjust the data structure that can be associated with the task codes. In this example, the network server may perform automated adjustment of the task competition specification on behalf of the subscriber as described herein.

The input data 430 as shown includes the components as described in FIG. 3 above to simplify the illustration. However, different other input data may be adjusted or preconfigured such as qualifications to participate in the task competition, identification of items in the targeted menus, amount or measurement for each targeted item, and the like.

### Example Employee's User Device

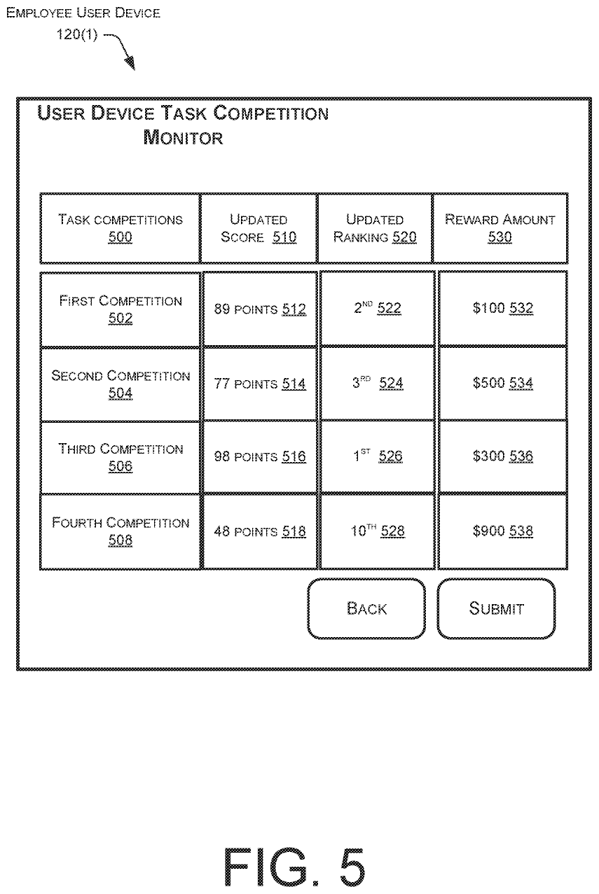

FIG. 5 is an example user interface of the first employee's user device 120(1) that shows accessing the competition management app to view the competition notification on one or more task competitions participated in by the employee. The competition notification such as the competition notification 182 of FIG. 1 may provide the task performance indicator feedback that can be used by the employee as a reference in determining current status towards a particular goal. In the illustrated example, the user interface may show task competitions 500, updated score 510, updated ranking 520, and reward amount 530. The task competitions 500 may correspond to the task competitions 310 of FIG. 3 and can include restaurant task contests that the employee is participating in. Each of these task competitions may be implemented to promote one or more products or to engage the employees to enhance the services that are being offered by their employer. The task competitions 500 may include the task competitions from different employers that can respectively sponsor the prizes to be apportioned to the task competition participants.

For example, the task competitions 500 may include a first competition 502, second competition 504, third competition 506, and a fourth competition 508. Each of these tasks may be associated with one or more input data or components (not shown) that can be used in the one or more corresponding sub-algorithms to determine the scores of the task competition participants. For example, the first competition 502 may include the selling of liquors and the input variables may include sizes and/or brands of the liquor sold. In another example, the second competition 504 may include gathering of tips and the input variables may include amount of tips and number of customers served by the task competition participant. In another example, the third competition 506 may include selling targeted restaurant menus and the input variables may include identification and amount served by the task competition participant. In another example, the fourth competition 508 may include serving repeat customers and the input variables may include day of the week and the type of menu served by the task competition participant, and so on.

For each of the task competitions 500, a corresponding updated score 510 may be calculated continuously, periodically, or upon detection of a triggering event. For example, and upon detection of the triggering event, the updated core 510 for the first competition 502, second competition 504, third competition 506, and a fourth competition 508 may include “89 points” 512, “77 points” 514, “98 points” 516, and “48 points” 518, respectively. Further, a corresponding updated ranking 520 may be determined by comparing the updated scores of the task competition participants with a set value or threshold value. For example, the task competition participant associated with the user device 120(1) has a ranking of “2^{nd} ranking” 522, “3^{rd} ranking” 524, “1^{st} ranking” 526, and “10^{th} ranking” 528 upon calculation of the updated scores for the first competition 502, second competition 504, third competition 506, and a fourth competition 508, respectively. Here, the task competition participant may be motivated to exert more effort for the fourth competition 508 to earn a higher reward amount 530. For illustration purposes, the reward amount 530 for the first competition 502, second competition 504, third competition 506, and a fourth competition 508 includes “$100” 532, “$500” 534, “$300” 536, and “$900” 538, respectively.

In some embodiments, the competition notification in user's device may include real-time notification alert (not shown) that the participant moved to a higher level or rank, time left to complete the goal of the task competition, stage of the participant in achieving the goal of the task competition, level of difficulty of the task competition, statistical chances of the participant to win the task competition, statistical chances of increasing scores based on the current position of the employee for the day, and the like.

### Example Implementation of Reconciling Regular Gratuities

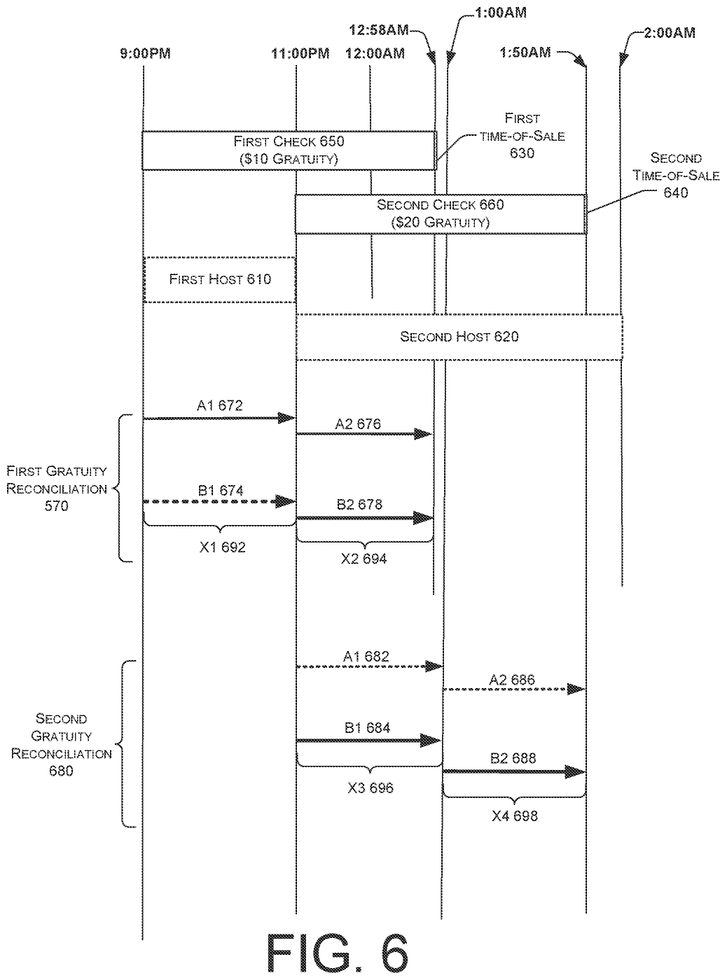

FIG. 6 is diagram illustrating an example apportionment of the regular gratuity at the end of the gratuity period. In one embodiment, as further described below, the gratuity period may be defined by a time-of-sale. In this embodiment, the event or activity during the apportionment of the regular gratuity may be used as a triggering event for the distribution of the competition rewards as described herein. For example, the time-of-sale may trigger the running of the sub-algorithms 340 of FIG. 3 to update the competition notifications that can be transmitted in real-time to the participants of the task competitions.

FIG. 6 shows an example of (regular) gratuity distribution over completed orders that span/range from an opening of the corresponding order/transaction to an entry of a time-of-sale for each of the orders/transactions. The entry of the time-of-sale may indicate the completion of the corresponding transaction such as when actual payment is made for the service rendered or completion of a customer's order (e.g., payment of a bar tab bill). FIG. 6 illustrates a reconciliation of pooled regular gratuity upon the entry of the time-of-sale, which can define an end of the corresponding aperiodic gratuity distribution period for the rendered service or completed order. As shown, a first host 610 and a second host 620 may represent subscriber employees while a first time-of-sale 630 and a second time-of-sale 640 can represent entries of a first check 650 and a second check 660, respectively. The first check 650, for example, may include payment of a bar tab that was opened by a first customer (not shown) at 9:00 PM and closed at 12:58 AM while the second check 660 can include another payment for a separate bar tab that was opened by a second customer (not shown) at 11:00 PM and closed at 1:50 AM. The opening of the bar tab may include an entry of a bar number (not shown) that can be assigned or associated with a particular customer while the closing of the bar tab may include an entry of payment or other information that can indicate a completion of transaction. FIG. 6 further shows a first gratuity reconciliation 670 and a second gratuity reconciliation 680 that can represent apportioning of the pooled regular gratuities at the time of the first time-of-sale 630 and the second time-of-sale 640, respectively.

Referencing the first gratuity reconciliation 670, A1 672 and B1 674 may represent respective percentage sharing of the first host 610 and the second host 620 at a first time window X1 692. Further, A2 676 and B2 678 may represent respective percentage sharing of the first host 610 and the second host 620 at a second time window X2 694. In FIG. 6, the respective percentage sharing, first time window X1 692, and the second time window X2 694 are illustrated for purposes of apportioning the regular gratuities.

Referencing the second gratuity reconciliation 680, A1 682 and B1 684 may represent respective percentage sharing of the first host 610 and the second host 620 at a third time window X3 696. Further, A2 686 and B2 688 may represent respective percentage sharing of first host 610 and the second host 620 at a fourth time window X4 698. In FIG. 6, the respective percentage sharing, third time window X3 696, and the fourth time window X4 698 are illustrated for purposes of apportioning the regular gratuities.

In one embodiment, the first time-of-sale 630 may define an end of an aperiodic gratuity distribution period and can be associated with a completion of a transaction that is paid using the first check 650. For example, the transaction was opened at 9:00 PM and closed at 12:58 AM upon an entry of transaction payment, which is represented by the first time-of-sale 630. In this example, the pooled gratuity ($10) may be immediately apportioned to the first host 610 and the second host 620 upon completion of the transaction. The reconciliation of the pooled regular gratuity ($10) at the first time-of-sale 630 may utilize sub-algorithm or sub-algorithms for apportioning the regular gratuities.

For example, referencing the first gratuity reconciliation 670, the first time window X1 692 and the second time window 694 may correspond to different percentage sharing by the first host 610 and the second host 620 over different time periods within the aperiodic gratuity distribution period of 3 hours and 58 minutes (i.e., 9:00 PM to 12:58 AM). At the first time window X1 692, note that even though there is no overlapping between working shift/hours by the second host 620 (11:00 PM to 2:00 AM) with the first host 610 (9:00 PM to 11:00 PM), one or more arbitrary conditions other the overlapping of working hours may be associated with the percentage sharing—B1 674 of second host 620. For example, the second host 620 is preconfigured to share 10% of a portion of the tips—gratuity during the first time window X1 692 on account of the second host's position even though the second host did not work between 9:00 PM to 11:00 PM.

Referencing the second time window X2 694 of the first gratuity reconciliation 670, the second time window X2 694 may be triggered by changes in the percentage sharing of the first host 610 and the second host 620 upon an occurrence of a condition such as the clocking in by the second host 620 at 11:00 PM. Here, a different sub-algorithm may be utilized to calculate the respective percentage sharing of the first host 610 and the second host 620 of the portion of the tip-gratuity at the second time window X2 694. In some instances, the percentage sharing of the first host 610 and the second host 620 at the first time-of-sale 630 may be linearly based upon a number of minutes they served or provided for the completion of the transaction. In these instances, the first host 610 and the second host 620 may divide the $10 pooled tip-gratuity based upon their number of work hours such as 2 hours (9:00 PM to 11:00 PM) for the first host 610 and 1 hour 58 minutes (11:00 PM to 12:58 AM) for the second host 620.

In one embodiment, the amount of gratuity to be pooled ($10) at the first time-of-sale 630 may be equated with a summation of the sub-algorithms over the first time window X1 692 and second time window X2 694 to calculate the apportioned tip-gratuities for the first host 610 and the second host 620. In this embodiment, the percentage sharing of the first host 610 is a function of the percentage sharing of the second host 620 and as such, the percentage sharing of each host may be calculated.

Referencing the second gratuity reconciliation 680, the second time-of-sale 640 may define an end of another aperiodic gratuity distribution period and can be associated with completion of a transaction that is associated with the second check 660. For example, the transaction was opened at 11:00 PM and closed at 1:50 AM upon an entry of transaction payment, which is represented by the second time-of-sale 640. In this example, the pooled tip-gratuity ($20) may be immediately apportioned to the first host 610 and the second host 620 upon completion of the transaction. The reconciliation of the pooled tip-gratuity ($20) at the second time-of-sale 640 may similarly utilize sub-algorithm or sub-algorithms for apportioning regular gratuities.

For example, referencing the second gratuity reconciliation 680, the third time window X3 696 and the fourth time window 698 may correspond to different percentage sharing by the first host 610 and the second host 620 over different time periods within the aperiodic gratuity distribution period of 2 hours and 50 minutes (11:00 PM to 1:50 AM). At the third time window X3 696, note that even though there is no overlapping between working hours of the second host 620 (11:00 PM to 2:00 AM) with the first host 610 (9:00 PM to 11:00 PM), one or more arbitrary conditions other the overlapping of working hours may be associated with the percentage sharing A1 682 of the first host 610. For example, the first host 610 is preconfigured to have a percentage share of A1 682 for the third time window X3 696 on account of first host's position even though the first host did not work between 11:00 PM to 1:00 AM. At the fourth time window X4 698, the first host 610 may be preconfigured to have a different percentage share—A2 686 on account, for example, of first host's reward as employee of the year even though the first host did not work between 1:00 AM to 1:50 AM. In these examples, the one or more arbitrary preconfigured conditions that can be associated with each host can be programmed by a subscriber administrator such as a store manager. Further, the preconfigured one or more conditions can be preconfigured at different cycles like implementing aperiodic gratuity distribution periods for the first half of the month and observing periodic gratuity distribution periods in the second half.

Similar to the first gratuity reconciliation 670, the amount of tip-gratuity to be pooled ($20) at the second time-of-sale 640 may be equated with a summation of the sub-algorithms over the third time window X3 696 and fourth time window X4 698 to calculate the apportioned gratuities for the first host 610 and the second host 620. Since the percentage sharing of the first host 610 is a function of the percentage sharing of the second host 620 at each time window, then the percentage sharing of each host may be calculated.

In one embodiment, the event or activity during the apportionment of the regular gratuities as described above may be used as a triggering event to update competition notifications to be transmitted to the task competition participants. For example, the accounting management server may use the time-of-sale as a triggering event to update the ranking, status, and other information associated with the competition notification such as the competition notification 182 of FIG. 1. In another example, the accounting management server may use the opening of the tab as the triggering event to update the competition notification 182, and so on.

### Example Implementation— Using Task Competition to Promote Product or Services

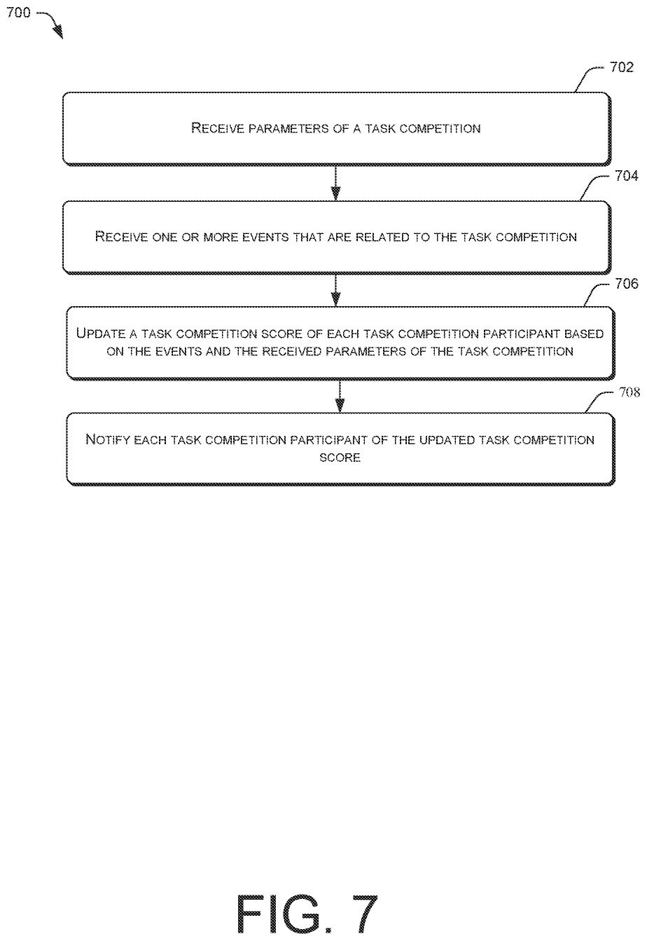

FIG. 7 is a flow diagram of an example process in accordance with at least one embodiment. In the following discussion of FIG. 7, continuing reference is made to the elements and reference numerals shown in and described with respect to the network server 202 of FIG. 2. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 702, the network server 202 may receive parameters of a task competition. For example, the parameters may include identification of the task competition, preconfigured input data or components of the identified task competition, scoring metrics, preconfigured sub-algorithms, and associated information such as employee ID, job position, and the like. The parameters may define the goals of the task competition and can be configured during the competition creation process as described above with reference to FIG. 4.

At block 704, the network server 202 may receive events that are related to the task competition. For example, the events or activities may include closing of a dinner transaction at the time-of-sale as described herein. In another example, the events or activities may include entering an amount of tip, opening a tab for a customer, registering a car during car valeting, registering a repeat customer, and the like. In these examples, the network server 202 may use the received event or activity as a triggering event for distributing the competition rewards as described herein.

At block 706, the network server 202 may update a task competition score or status of each task competition participant based at least in part on the received events and the parameters of the task specification. For example, the competition notification 182 of FIG. 1 may display output data such as raw scores of the participant, ranking of the participant towards the goal of the task competition, amount of time or task left for the goal to be finished or achieved, statistical chance of the participant to achieve the goal, and the like.

At block 708, the network server 202 may notify each of the task competition participants of the updated task competition score. For example, a user interface of the user device associated with the task competition participant may display the competition notification 182 including the task competitions, updated scores, updated ranking, and the reward amount as described in FIG. 5 above.

### Example Implementation— Adding Task Competition Prizes to Winning Employees

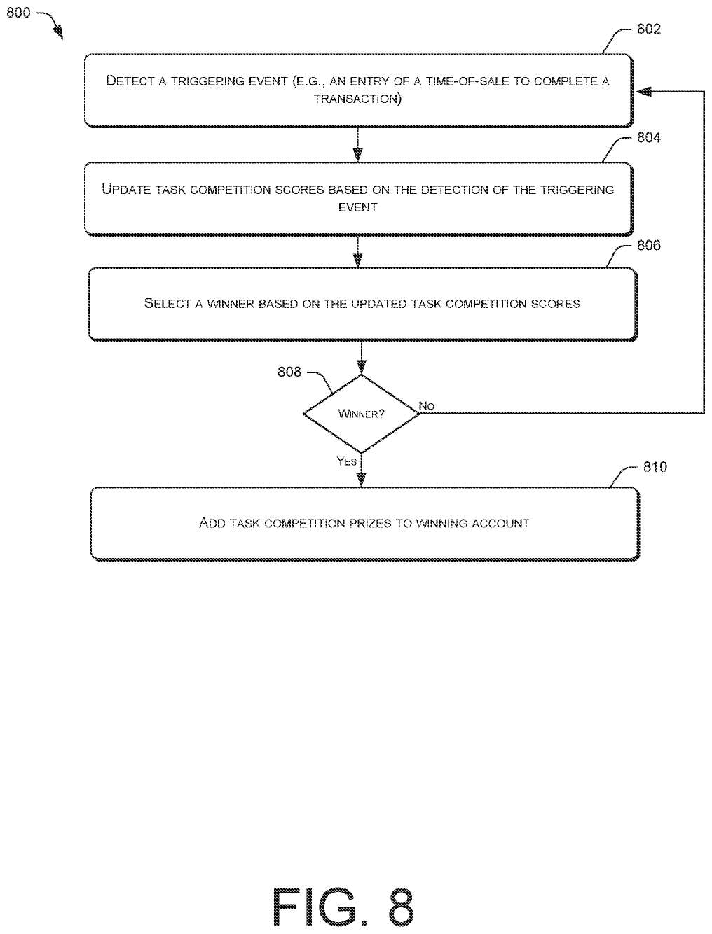

FIG. 8 is a flow diagram of another example process 800 in accordance with at least one embodiment. In the following discussion of FIG. 8, continuing reference is made to the elements and reference numerals shown in and described with respect to the network server 202 of FIG. 2. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 802, the network server 202 may detect an event that triggers running of one or more sub-algorithms that are associated with a particular task competition. For example, the network server 202 may detect an entry of a time-of-sale in the POS to complete a transaction. In this example, the detected entry of the time-of-sale may trigger the sub-algorithm for calculating the scores and other information in the competition notification that can be transmitted in real-time to the task competition participants.

At block 804, the network server 202 may update task competition scores based on the detection of the triggering event. For example, the network server 202 may run the first sub-algorithm 342 of FIG. 3 upon the detection of entry of the amount of tip and/or number of customers at the time-of-sale. In this example, the running of the first sub-algorithm 342 may update the scores of the task competition participant for the selling of liquor competition. In another example, the network server 202 may run a separate algorithm to update the scores of task competition participant over the task competition for selling targeted menus. In this other example, the components for selling targeted menus may include identification of the targeted menu to be sold, quantity of the targeted menu, etc.

At block 806, the network server 202 may select a winner based on the updated task competition scores. In one example, the network server 202 may use a set value or a threshold value to determine the winner of the task competition. In another example, the network server 202 may rank the task competition participants on the updated competition scores. In these examples, the ranking, set value, or threshold value can be used as a reference to select or determine the task competition winner.

At block 808, the network server 202 may determine a winner based on the updated task competition scores. If a winner is selected or determined (“Yes” at decision block 808), then, at block 810, the network server 202 may notify the task competition participant and facilitate adding the task competition prizes to the winning employee's account. However, if no winner is selected (“No” at decision block 808), then, at block 802, the network server 202 may continue monitoring the network of the triggering event such as another entry of the time-of-sale to complete a particular transaction.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed is:

1. One or more non-transitory computer-readable storage media storing computer-executable instructions that upon execution cause one or more processors to perform acts comprising:
receiving parameters of a restaurant task competition, wherein the parameters include at least an identification of the restaurant task competition, one or more components associated with the identification of the restaurant task competition, and a scoring metric that includes a scoring rule on the one or more components to determine a task competition score of a task competition participant;
detecting a triggering event;
updating the task competition score based at least in part on the detected triggering event; and
notifying the task competition participant based at least in part on the updated task competition score.

2. The one or more non-transitory computer-readable storage media of claim 1, wherein the acts further comprise:
identifying a preconfigured weight of each component; and
using the preconfigured weight of each component in one or more algorithms to update the task competition score.

3. The one or more non-transitory computer-readable storage media of claim 1, wherein the updated task competition score is compared to a set value or a threshold value to determine a winner of the restaurant task competition.

4. The one or more non-transitory computer-readable storage media of claim 1, wherein the restaurant task competition includes at least a selling of liquors or an earning of tips from a transaction.

5. The one or more non-transitory computer-readable storage media of claim 4, wherein the triggering event includes a closing of the transaction at a time-of-sale.

6. The one or more non-transitory computer-readable storage media of claim 1, wherein the one or more components are preconfigured for different restaurant task competitions.

7. The one or more non-transitory computer-readable storage media of claim 6, wherein a distribution weight of each component is manually preconfigured by a store manager via accessing of a competition management application.

8. The one or more non-transitory computer-readable storage media of claim 1, wherein the detecting of the triggering event includes receiving an activity from an apportionment of a regular gratuity.

9. The one or more non-transitory computer-readable media of claim 1, wherein the notifying includes transmitting the updated task competition score to a mobile device of the task competition participant.

10. A server-implemented system, comprising:
one or more processors;
computer-executable instructions stored in a memory that, if executed by the one or more processors, cause the one or more processors to perform operations comprising:
receiving parameters of a restaurant task competition, wherein the parameters include at least an identification of the restaurant task competition, one or more components associated with the identification of the restaurant task competition, and a scoring metric that includes a scoring rule on the one or more components to determine a task competition score of a task competition participant;
detecting a triggering event;
updating the task competition score based at least in part on the detected triggering event; and
notifying the task competition participant based at least in part on the updated task competition score.

11. The server-implemented system of claim 10, wherein the operations further comprise:
identifying a preconfigured weight of each component; and
using the preconfigured weight of each component in one or more algorithms to update the task competition score.

12. The server-implemented system of claim 10, wherein the updated task competition score is compared to a set value or a threshold value to determine a winner for the restaurant task competition.

13. The server-implemented system of claim 10, wherein the restaurant task competition include at least a selling of liquors or an earning of tips from a transaction.

14. The server-implemented system of claim 13, wherein the triggering event includes a closing of the transaction at a time-of-sale.

15. The server-implemented system of claim 10, wherein the one or more components are preconfigured for different restaurant task competitions.

16. The server-implemented system of claim 15, wherein a distribution weight of each component is manually preconfigured by a store manager via accessing of a competition management application.

17. A computer-implemented method, comprising:
receiving parameters of a restaurant task competition, wherein the parameters include at least an identification of the restaurant task competition and a scoring metric to determine a task competition score for a task competition participant;
detecting a triggering event;
updating the task competition score of the task competition participant based at least in part on the detected triggering event; and
notifying the task competition participant based at least in part on the updated task competition score.

18. The computer-implemented method of claim 17 further comprising:
identifying a preconfigured weight of one or more input variables that are associated with the restaurant task competition; and
using the preconfigured weight of the one or more input variables in one or more algorithms to update the task competition score.

19. The computer-implemented method of claim 18, wherein the updated task competition score is compared to a set value or threshold value to determine a winner of the restaurant task competition.

20. The computer-implemented method of claim 17, wherein the detecting of the triggering event includes receiving an activity from an apportionment of a regular gratuity.
